(19) United States
(12) Patent Application Publication
(10) Pub. No.: US 2022/0064820 A1
(43) Pub. Date: Mar. 3, 2022

(54) Fibers and Articles Comprising Same

(71) Applicant: Dooley Chemicals, LLC, Chattanooga, TN (US)

(72) Inventors: Kevin R. Hrebenar, Chattanooga, TN (US); Frederick E. Wilson, III, Chattanooga, TN (US); David L. Halstead, Chattanooga, TN (US); Charles V. Hinton, Chattanooga, TN (US)

(73) Assignee: Dooley Chemicals, LLC

(21) Appl. No.: 17/412,503

(22) Filed: Aug. 26, 2021

Related U.S. Application Data
(60) Provisional application No. 63/070,605, filed on Aug. 26, 2020.

(51) Int. Cl. D01F 1/10; D01F 6/06; D01F 6/60; D01F 6/62

(52) U.S. Cl. CPC D01F 1/10; D01F 6/06; D01F 6/60; D10B 2331/04; D10B 2321/022; D10B 2331/02; D01F 6/62

(57) ABSTRACT

The invention is related to an improved fiber and articles comprising the improved fibers. The fiber comprises:
90 wt % to 99.99 wt % thermoplastic resin; and
0.01 wt % to 10 wt % additive is defined by Formula (I):

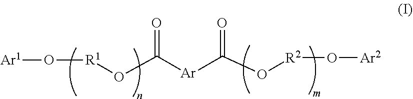

wherein:
Ar is selected from the group consisting of aryl, monosubstituted aryl and polysubstituted aryl, heteroaryl, monosubstituted heteroaryl and polysubstituted heteroaryl;
Ar¹ and Ar² are independently selected from the group consisting of aryl, monosubstituted aryl and polysubstituted aryl, heteroaryl, monosubstituted heteroaryl and polysubstituted heteroaryl; R¹ and R² are independently an alkylene radical having 2-20 carbon atoms; and n and m are independently 1-20.

### CROSS-REFERENCE TO RELATED APPLICATIONS

The present application claims the benefit of priority to pending U.S. Provisional Patent Application No. 63/070,605 filed Aug. 26, 2020 which is incorporated herein by reference.

### FIELD OF THE INVENTION

The present invention is related to an improved fiber and articles comprising the improved fiber. More specifically, the present invention is related to improved fibers which are particularly suitable for use in a fiber matrix or as a resin reinforcement.

### BACKGROUND

The desire for improved materials continues unabated after decades of improvements. In spite of the effort there is still a need in the art for improved materials. This need is particularly realized in the desire for materials capable of use in an article requiring gas permeation and in reinforced materials requiring specific strength requirements yet having flexibility and elongation capabilities.

The present invention provides inventive fibers which are particularly suitable for use in a fiber matrix and in reinforced resins.

### SUMMARY OF THE INVENTION

The present invention is related to an improved fiber which is suitable for use in a fiber matrix and in reinforced resins.

More specifically, the present invention is related to an improved fiber with an improved ball burst strength, improved pilling resistance, reduced abrasion and reduced fuzzing wherein the fiber is particularly suitable for use in a fiber matrix and in reinforced resins.

These and other embodiments, as will be realized, are provided in a fiber comprising:

90 wt % to 99.99 wt % thermoplastic resin; and
0.01 wt % to 10 wt % additive is defined by Formula (I);

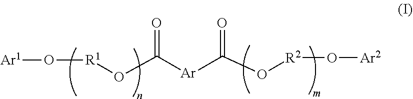

wherein:
Ar is selected from the group consisting of aryl, monosubstituted aryl and polysubstituted aryl, heteroaryl, monosubstituted heteroaryl and polysubstituted heteroaryl;
Ar¹ is selected from the group consisting of aryl, monosubstituted aryl and polysubstituted aryl, heteroaryl, monosubstituted heteroaryl and polysubstituted heteroaryl;
Ar² is selected from the group consisting of aryl, monosubstituted aryl and polysubstituted aryl, heteroaryl, monosubstituted heteroaryl and polysubstituted heteroaryl;
R¹ is an alkylene radical having 2-20 carbon atoms;
R² is an alkylene radical having 2-20 carbon atoms;
n=1-20; and
m=1-20.

Yet another embodiment is provided in a fiber matrix comprising a primary resin and fibers comprising 90 wt % to 99.99 wt % thermoplastic resin; and

0.01 wt % to 10 wt % additive is defined by Formula (I).

Yet another embodiment is provided in an article comprising fibers in a primary resin wherein the fibers comprise 90 wt % to 99.99 wt % thermoplastic resin and 0.01 wt % to 10 wt % additive defined by Formula (I).

Yet another embodiment is provided in a method for forming a material comprising:

mixing a thermoplastic resin and an additive to form a melt comprising 90 wt % to 99.99 wt % of the thermoplastic resin and 0.01 wt % to 10 wt % of the additive wherein the additive is defined by Formula (I); and
extruding the melt to form fibers.

### BRIEF DESCRIPTION OF DRAWINGS

FIG. 1 is a schematic side view representation of an embodiment of the invention.

FIG. 2 is a schematic side view representation of an embodiment of the invention.

FIG. 3 is a schematic side view representation of an embodiment of the invention.

FIG. 4 is a schematic side view representation of an embodiment of the invention.

### DESCRIPTION

The present invention is related to an improved fiber and fiber matrix or reinforced article formed therewith.

More specifically, the present invention is related to improved fibers comprising a, preferably thermoplastic, polymer wherein the fibers exhibit substantially improved fiber tensile strength when measured according to ASTM D2256, improved Martindale abrasion resistance when measured according to ASTM 4966 or Taber abrasion resistance according to ASTM D6797 and improved fabric burst strength values when measured according to ASTM D6797.

The invention will be described with reference to the figures forming an integral, non-limiting, component of the disclosure. Throughout the various figures similar elements will be numbered accordingly.

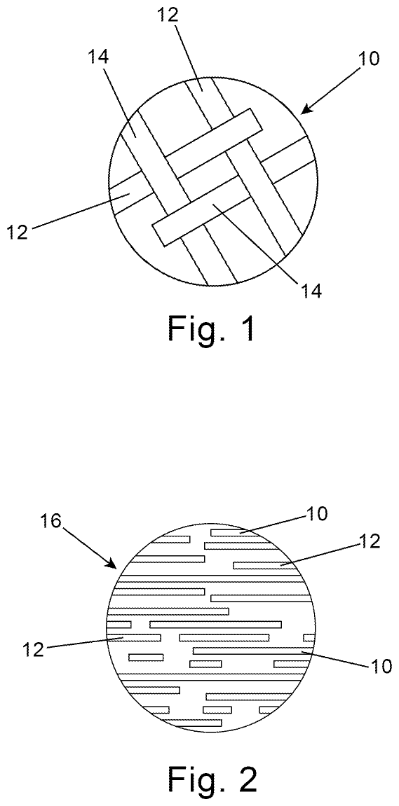

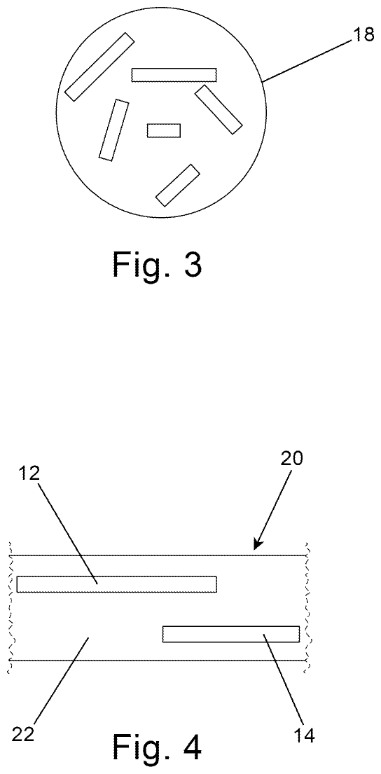

Embodiments of the invention are illustrated schematically in FIGS. 1-3. In FIGS. 1-3, a fiber matrix, 10, is represented wherein the fiber matrix comprises inventive fibers, 12, and optional, but preferred, secondary fibers, 14. The fiber matrix may be a woven matrix, as illustrated in FIG. 1, wherein a majority of the fibers are interlaced. The fiber matrix may be an oriented matrix, 16, as illustrated in FIG. 2, wherein a majority of the fibers are parallel. The fiber matrix may be a random matrix, 18, as illustrated in FIG. 3, wherein for a majority of the fibers the arrangement of adjacent fibers is not correlated. The fiber matrix may have a combination of woven matrix, oriented matrix and random matrix either in a common layer or in different layers.

The fiber matrix may be self-sustaining, wherein the fiber matrix can be used in the manufacture of articles without the addition of materials to adhere adjacent fibers to each other. In another embodiment at least one of either the inventive fibers or the secondary fibers may have adhesion groups, preferably on the surface, which increase adhesion between adjacent fibers by electrostatic attraction, ionic affinity or a covalent bond with the proviso that the fibers remain as discrete fibers as evidenced by observation under magnification.

An embodiment of the invention is illustrated schematically in FIG. 4. In FIG. 4 a portion of a reinforced article, 20, is illustrated in cross-sectional view. The reinforced article comprises inventive fibers, 12, and secondary fibers, 14, in a primary resin, 22. The orientation of the fibers in the primary resin may be interleaved, oriented, random or combinations thereof. The fibers reinforce the primary resin. Particularly preferred primary resins include polyester, nylon, polypropylene and combinations thereof. It is preferred that the reinforced article comprises 5-85 wt % primary resin. It is preferred that the reinforced article comprise 15-95 wt % total fiber.

The fibers comprise a, preferably thermoplastic, polymer with an additive incorporated therein. The polymer is selected from the group consisting of polyester, nylon, polypropylene and combinations thereof.

The additive is defined by Formula (I).

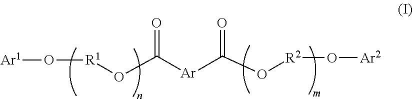

wherein Ar is selected from the group consisting of aryl, monosubstituted aryl and polysubstituted aryl, heteroaryl, monosubstituted heteroaryl and polysubstituted heteroaryl; Ar¹ is selected from the group consisting of aryl, monosubstituted aryl and polysubstituted aryl, heteroaryl, monosubstituted heteroaryl and polysubstituted heteroaryl; Ar² is selected from the group consisting of aryl, monosubstituted aryl and polysubstituted aryl, heteroaryl, monosubstituted heteroaryl and polysubstituted heteroaryl; R¹ is an alkylene radical having 2-20 carbon atoms; R² is an alkylene radical having 2-20 carbon atoms; n=1-20 and m=1-20.

In a particularly preferred embodiment, Ar is a 1,4-disubstituted phenyl group, R¹ and R² represent —CH₂CH₂—, Ar¹ and Ar² are phenyl, and n and m are 1 which is referred to herein as PEM, bis(2-phenoxyethyl)terephthalate, which may be represented as:

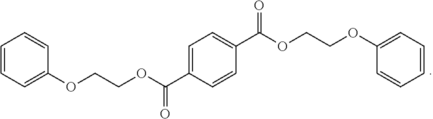 [SMILES: O=C(OCCOc1ccccc1)c1ccc(C(=O)OCCOc2ccccc2)cc1]

Additional orientations may be represented as:

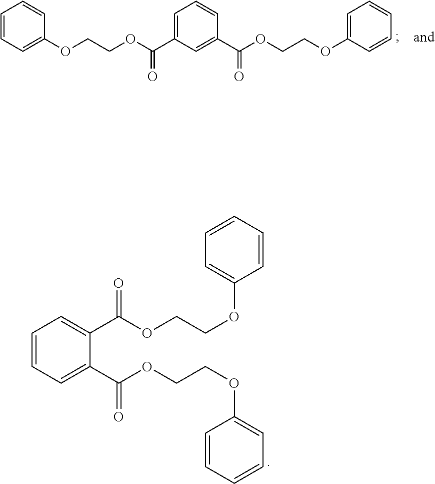 [SMILES: O=C(OCCOc1ccccc1)c1cccc(C(=O)OCCOc2ccccc2)c1 ; O=C(OCCOc1ccccc1)c1ccccc1C(=O)OCCOc1ccccc1]

In a particularly preferred embodiment Ar¹ and Ar² are a naphthyl group. In Formula I, Ar can be 1,2-substituted, 1,3-substituted or 1,4-substituted with 1,4-substituted being preferred.

Examples of Ar¹ and Ar² independently include substituted phenyl groups such as chlorophenyl and other halogenated phenyl groups, alkylphenyl groups such as octylphenyl, nonylphenyl, or dodecylphenyl, cyano- or nitro- or acid- or ester-substituted phenyl groups, 6-membered ring heterocycles such as pyridines and substituted pyridines, 5-membered ring heterocycles containing nitrogen or oxygen or sulfur, such as furans, pyrroles, imidazoles, polyaromatic groups such as 1- or 2-naphthyl groups. In at least one embodiment Ar¹ and Ar² are the same.

Examples of Ar include phthalic acid and esters thereof, isophthalic acid and esters thereof, terephthalic acid and esters thereof, polyaromatic diacids such as biphenyl diacid and diphenyl ether diacids, alpha- and omega-substituted aliphatic diacids.

Examples of R¹ and R² independently include ethyl, 2-methylethyl, 2-ethylethyl.

In an embodiment, at least one of Ar¹ or Ar² is phenyl, Ar is terephthaloyl, at least one of R¹ or R² is ethyl, n is 1 to 2 and m is 1 to 2. In another embodiment, at least one of Ar¹ or Ar² is 2-naphthyl, Ar is terephthaloyl, at least one of R¹ or R² is ethyl, n is 1 to 2 and m is 1 to 2. In another embodiment, at least one of Ar¹ or Ar² is 1-naphthyl, Ar is terephthaloyl, at least one of R¹ or R² is ethyl, n is 1 to 2 and m is 1 to 2. Exemplary structures include:

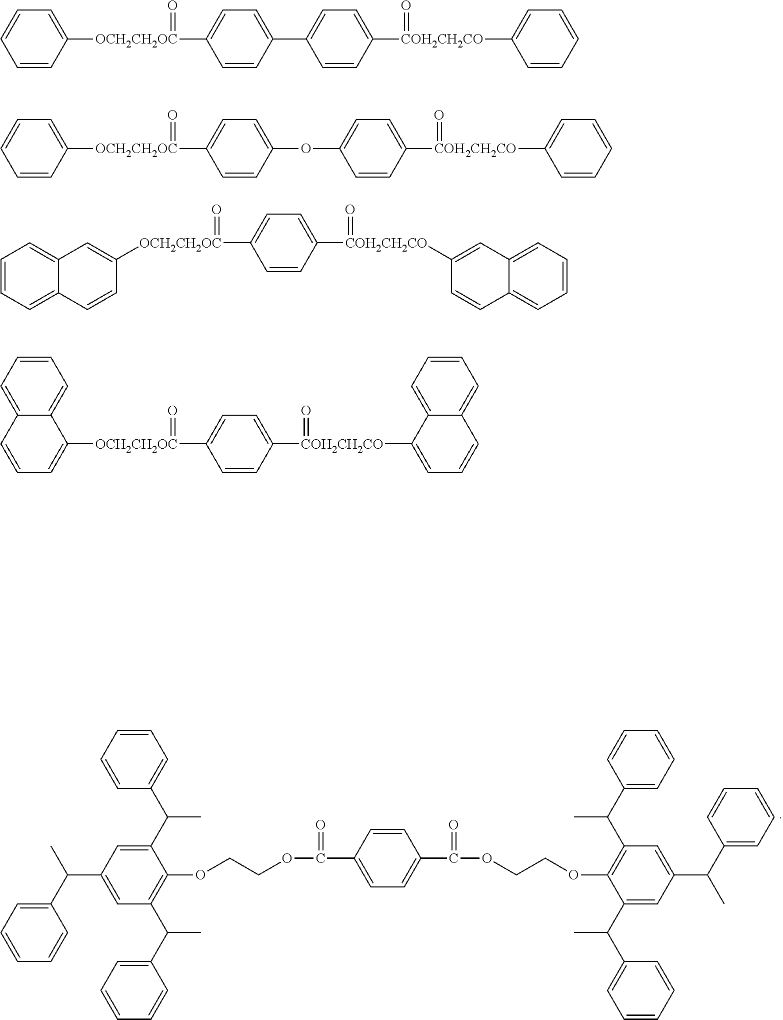

The fibers have a preferred aspect ratio of at least 10:1, preferably at least 100:1 and more preferably at least 1,000:1 with 1,000,000:1 or greater being suitable in some applications such as the formation of a pultruded product. Aspect ratio is the ratio of the longest dimension, or length, to the equivalent diameter.

The equivalent diameter, is preferably in the range of 1 micron to 1 millimeter. For the purposes of this invention the equivalent diameter is defined as the diameter of a circle having the same surface area as a cross-sectional area taken perpendicular to the longest dimension.

In a preferred method for forming the inventive fibers a composition comprising a, preferably thermoplastic, polymer and the additive are extruded through a spinneret and the extruded filaments are allowed to solidify in fiber form. The filaments may be cut into segments to form discrete fibers or they may be incorporated into a resin such as by pultrusion or the like. In some instances the fibers are surface treated, referred to in the art as sizing, to improve the surface characteristics or compatibility with resin.

The fiber preferably represents at least 0.01 wt % to no more than 10 wt % additive and up to 99.99 wt % polymer. More preferably the fiber represents at least 0.02 wt % additive, even more preferably at least 0.03 wt % additive, more preferably at least 0.04 wt % additive, even more preferably at least 0.05 wt % additive, even more preferably at least 0.1 wt % additive, even more preferably at least 0.2 wt % additive, and even more preferably at least 0.3 wt % additive. In a preferred embodiment the fiber comprises less than 5 wt % additive, more preferably less than 3 wt % additive and even more preferably less than 1 wt % additive.

In some embodiments modifiers, preferably up to no more than 10 wt %, may be added to the polymer to provide additional functionality. Examples of modifiers would include traces of metals or metal salts used as tracers for identification of specific lots of fiber, TiO₂ or similar materials may be added as delustrants, and a host of organic species can be added for such special purposes as antistatic agents or flame retardants. There may also be considerable quantities of residual monomer or small oligomers dissolved in the polymer matrix. Specific modifiers include colorants and pigments, such as TiO₂, Na-sulphoisophthalate for cationic dying, organic silicones for low pill fibers, phosphinic acid compounds for flame retardant fibers or polyethylene glycol (PEG) for deep dying fibers. The modifiers may be added during the polymer synthesis process. The need to add modifiers to the melt phase polycondensation is contrary to the desire to maximize process flexibility and it is therefore preferable to add the modifiers as masterbatch prior to spinning processes.

Secondary fibers are preferably selected from natural fibers, man-made fibers, metallic fibers, carbon fibers, silicon fibers and polymer fibers and may include microfibers. Particularly preferred secondary fibers are polyamides, polyesters, phenol-formaldehyde, polyvinyl chloride, polyolefins, acrylic polyesters, aromatic polyamides, polyethylene, elastomers, polyurethanes and mixtures thereof.

In an embodiment, the additive is incorporated in the polymer at the intended concentration during polymerization. In another embodiment the polymer is supplied to an extruder as pellets and the additive is added during the melt/extrusion process. Feeding additive into the extruder is preferred as this insures a very homogeneous distribution of the additives within the polymer.

In an embodiment a masterbatch may be utilized wherein the masterbatch is added to a polymer during the melt/extrusion process. By way of example, a masterbatch comprising 10-50 wt % additive and 50-90 wt % polymer could be prepared. Prior to fiber formation, such as during melt/extrusion, the masterbatch is added into the extruder to achieve the desired final wt % of additive.

In a masterbatch process materials are added to the polymer, prior to the formation of fibers, to impart desirable properties to the ultimate fiber. A masterbatch is a solid additive used for coloring plastics, referred to as color masterbatch, or for imparting other properties to plastics. A masterbatch is a concentrated mixture of pigments and/or modifiers or additives encapsulated during a heat process into a carrier resin which is then cooled and cut into a granular shape, such as pellets. In a masterbatch process components of the fiber are mixed in the extruder. In an embodiment of a masterbatch process a first component comprises at least a thermoplastic resin. A second component comprises at least an ingredient at a first concentration wherein the ingredient comprises at least one of the group consisting of an additive, a colorant and a modifier. The first component and second component are added to an extruder, simultaneously or sequentially, prior to the extrusion head wherein the first component and second component are mixed prior to extrusion resulting in a fiber. The fiber comprises resin and the ingredient at a second concentration wherein the second concentration is less than the first concentration. The second component may comprise up to 40 wt % of the additive and more preferably up to 30 wt % of the additive.

Alternatives to using a masterbatch process include using fully-compounded material. Fully compounded materials may be more expensive and are less suitable for changes in color, particularly, if color is already present. Compounding from raw materials can be done on site, however this method is prone to issues such as incomplete dispersion of the colorants and additives. A fully-compounded material is added directly to the extrusion machine having the same chemical composition as the final fiber. With a fully-compounded material inventive additive, colorants, modifiers and the like are present in the fully-compounded material at the time of addition to the extrusion machine. With a fully-compounded material all components are mixed prior to addition of the fully-compounded material to an extruder.

As masterbatches are already premixed compositions, their use alleviates the issues with the additive or colorant clumping or insufficient dispersion. The concentration of the additive in the masterbatch is much higher than in the end-use polymer, but the additive is already properly dispersed in the host resin.

The masterbatches can be highly concentrated, relative to the target composition, with high let-down ratios. For example one 25 kg bag can be used for a ton of natural polymer in some embodiments without limit thereto. The relatively dilute nature of masterbatches, in comparison with the raw additives, allows higher accuracy in dosing small amounts of expensive components. The compact nature of the grains of solid masterbatches eliminates problems with dust, otherwise inherent for fine-grained solid additives. Solid masterbatches are also solvent-free, therefore they tend to have longer shelf life as the solvent won't evaporate over time. The masterbatch usually contains 40-65 wt % of the modifier or additive, but the range can be as wide as 15-80 wt %.

The carrier material of the masterbatch can be based on a wax, which is considered a universal carrier, or a specific polymer. The specific polymer can be identical to, or compatible with, the base plastic used. By way of non-limiting example; ethylene vinyl acetate (EVA), low density polyethylene (LDPE), polyethylene terephthalate (PET), polypropylene (PP), oxidized polyethylene or oxidized polypropylene can be used as carriers, particularly, for polyolefins and nylon; polystyrene can be used for acrylonitrile butadiene styrene (ABS), styrene acrylonitrile (SAN) and polycarbonates. When a carrier is different than the base plastic used, the carrier material may modify the resulting plastic's properties. The usual ratio of masterbatch to the base resin is 1 to 5 wt % without limit thereto. Multiple masterbatches can be used together to impart properties provided by the ingredient of each masterbatch. The carrier can also double as a plasticizer, which is common for liquid masterbatches, or the carrier may double as a processing aid.

The inventive additive and colorants exhibit a synergistic effect exhibited as a decrease in spectral transmission at an equivalent wt % of colorant measured in a common dimension. This allows the artisan to achieve a color density, determined either by transmissive or absorptive techniques, with lower concentration of colorant material in the resin.

The extrusion machines are usually fed with premixed granules of the host polymer and the masterbatch. The final mixing then occurs in the screw and extrusion part of the machine. This is sometimes prone to adverse effects, such as separation of the masterbatch and the base material in the machine's hopper. The masterbatch can be also added directly to the machine's screw.

The fibers are particularly suitable for use in commercial, industrial and textile materials such as carpets, garments, fabrics, textiles, tire cords, diaper fluff pulp or medical hygiene products.

### EXAMPLES

Fibers were produced using a Type 8230 Resin from Indorama. This material is described as a semi-dull PET resin. 150 denier fibers were extruded comprising 69 ends with each filament at ˜2-3 denier. The extrusion screw was 762 mm (30 inches) long with a 25.4 mm (1-inch) equivalent diameter with a high shear mixing section just prior to the extruder plate. There was also a 150-mesh filter screen with about 100 micron openings. Temperatures were as follows: Zone 1 at 240° C., zone 2 at 260° C., zone 3 at 265° C., zone 4 at 275° C., spin head at 280° C. and pump block at 290° C.

Fibers were produced as per the above with no additive as a Control, 0.5 wt % of a 30 wt % PEM containing masterbatch to achieve 0.15 wt % PEM (Inv. 1), and 1.5% of a 30% PEM containing masterbatch to achieve 0.45 wt % PEM (Inv. 2). The results of four samples of each were evaluated for fuzzing and pilling and six were evaluated for ball burst. The fiber tensile strength was for a single sample. The masterbatch comprises PEM in a mixture polyethylenes comprising 92.5 wt % Epolene® C-13 and 7.5 wt % Epolene® E-10 both of which are commercially available from Westlake Chemical of Houston Tex.

Pieces of sock fabric were knitted using the produced fibers for further testing including abrasion resistance, ball burst strength and fiber tensile strength. The knitted socks were produced on a FIBER ANALYSIS KNITTER SAMPLER LH-122 FAK-S by Lawson Hemphill. Fabric samples were tested according to ASTM procedures.

ASTM 4966 Standard Test Method for Abrasion Resistance of Textile Fabrics, also referred to as Martindale Abrasion Tester Method, refers to the testing of textile products according to Martindale standard system and tests the abrasion resistance of the fabric through the test. Abrasion resistance is the ability of a fabric to resist surface wear caused by flat rubbing contact with another material.

Fuzzing and pilling resistance is an important quality index of a textile product which directly affects the durability and application effect of the product. Martindale abrasion tester is used to test the abrasion and pilling resistance of fabric.

The Martindale abrasion test results, presented in Table 1, show improvements in fuzzing and pilling with the addition of 0.45 wt % of PEM. However, at 0.15 wt % of PEM the improvements are dramatic. The average number of cycles before fuzzing starts was 175 for the Control, 3975 for Inv. 1 and 375 for Inv. 2. The average number of cycles for pilling to begin was about 2750 for the control, over 9375 for Inv. 1 and over 7500 for Inv. 2, as shown in Table 2, with some inventive samples showing no pilling after 10,000 cycles.

TABLE 1
Martindale Abrasion Resistance-Evaluation of Fuzzing

| Cycles | Controls | | | | Inv. 1 | | | | Inv. 2 | | | |
|---|---|---|---|---|---|---|---|---|---|---|---|---|
| 100 | 5 | 5 | 4.5 | 5 | 5 | 5 | 5 | 5 | 5 | 5 | 5 | 5 |
| 200 | 4.5 | 4.5 | 4.5 | 4.75 | 5 | 5 | 5 | 5 | 4.5 | 5 | 5 | 5 |
| 300 | 4.5 | 4.5 | 4.5 | 4.5 | 5 | 5 | 5 | 5 | 4.5 | 5 | 5 | 5 |
| 400 | 4.5 | 4.5 | 4 | 4.25 | 5 | 5 | 5 | 4.75 | 4.5 | 4.5 | 5 | 4.75 |
| 500 | 4.25 | 4.25 | 4 | 4.25 | 5 | 5 | 5 | 5 | 4.5 | 4.5 | 4.75 | 4.75 |
| 750 | 4.25 | 4.25 | 4 | 4 | 5 | 5 | 5 | 5 | 4.5 | 4.5 | 4.75 | 4.75 |
| 1000 | 4.25 | 4.25 | 4 | 4 | 5 | 5 | 5 | 5 | 4.5 | 4.25 | 4.75 | 4.75 |
| 1500 | 4 | 4.25 | 4 | 4 | 5 | 5 | 5 | 4.75 | 4.5 | 4.25 | 4.75 | 4.5 |
| 2000 | 4 | 4.25 | 4 | 4 | 5 | 5 | 5 | 4.5 | 4.5 | 4.5 | 4.5 | 4.5 |
| 3000 | 4 | 4.25 | 4 | 4 | 5 | 5 | 4.75 | 4.5 | 4.5 | 4.5 | 4.5 | 4.5 |
| 4000 | 4 | 4.25 | 3.5 | 3.5 | 5 | 5 | 4.75 | 4.5 | 4.5 | 4.5 | 4.5 | 4.5 |
| 5000 | 4 | 4 | 3.5 | 3.5 | 5 | 4.75 | 4.75 | 4.5 | 4.5 | 4.5 | 4.5 | 4.5 |
| 7500 | 3.5 | 3 | 3 | 4 | 4.75 | 4.75 | 4.5 | 4.5 | 4 | 4 | 4 | 4 |
| 10,000 | 3.5 | 3 | 3 | 3.5 | 4.75 | 4.75 | 4.5 | 4.5 | 4 | 4 | 4 | 4 |

In Table 1, each column represents an independent sample resulting in four results for the control and each inventive sample. In Table 1 the fuzzing rating is based on a scale of 1-5 with 5 representing no fuzzing, 4 representing slight fuzzing, 3 representing moderate fuzzing, 2 representing severe fuzzing and 1 representing very severe fuzzing. In some instances a successive rating may be rated higher than a preceding rating due to loss of test fibers or the subjective nature of the rating.

TABLE 2
Martindale Abrasion Resistance-Evaluation of Pilling

| Cycles | Controls | | | | Inv. 1 | | | | Inv. 2 | | | |
|---|---|---|---|---|---|---|---|---|---|---|---|---|
| 100 | 5 | 5 | 5 | 5 | 5 | 5 | 5 | 5 | 5 | 5 | 5 | 5 |
| 200 | 5 | 5 | 5 | 5 | 5 | 5 | 5 | 5 | 5 | 5 | 5 | 5 |
| 300 | 5 | 5 | 5 | 5 | 5 | 5 | 5 | 5 | 5 | 5 | 5 | 5 |
| 400 | 5 | 5 | 5 | 5 | 5 | 5 | 5 | 5 | 5 | 5 | 5 | 5 |
| 500 | 5 | 5 | 5 | 5 | 5 | 5 | 5 | 5 | 5 | 5 | 5 | 5 |
| 750 | 5 | 5 | 5 | 5 | 5 | 5 | 5 | 5 | 5 | 5 | 5 | 5 |
| 1000 | 5 | 5 | 5 | 5 | 5 | 5 | 5 | 5 | 5 | 5 | 5 | 5 |
| 1500 | 5 | 5 | 5 | 5 | 5 | 5 | 5 | 5 | 5 | 5 | 5 | 5 |
| 2000 | 5 | 5 | 4 | 4 | 5 | 5 | 5 | 5 | 5 | 5 | 5 | 5 |
| 3000 | 4 | 5 | 4 | 4 | 4 | 5 | 5 | 5 | 5 | 5 | 5 | 5 |
| 4000 | 4 | 4.5 | 4 | 4 | 5 | 5 | 5 | 5 | 5 | 5 | 5 | 5 |
| 5000 | 4 | 4.5 | 3.5 | 3.5 | 5 | 5 | 5 | 5 | 4.75 | 5 | 4.75 | 5 |
| 7500 | 3 | 4.5 | 3 | 3 | 5 | 5 | 5 | 4 | 4.25 | 5 | 4.5 | 5 |
| 10,000 | 3 | 4 | 2.5 | 2.5 | 5 | 5 | 5 | 4 | 4.5 | 5 | 4.5 | 5 |

In Table 2, each column represents an independent sample resulting in four results for the control and each inventive sample. In Table 2 the pilling rating was based on a scale of 1-5 with 5 representing no pilling, 4 representing slight pilling, 3 representing moderate pilling, 2 representing severe pilling and 1 representing very severe pilling.

ASTM D6797 Standard Test Method for Bursting Strength of Fabrics-Constant-Rate-of-Extension (ORE) Ball Burst Test is used to determine the force required to rupture textile fabric by forcing a steel ball through the fabric with a constant-rate-of-extension tensile tester. This tear strength is basically used for knitted, lace, non-woven fabric, parachute fabrics, filters, sacks, nets etc. It is the uniformly distributed force over a given area applied to the fabric surface which is needed to break. This test is designed for fabric that will bear weight or withstand force, such as trampolines, pool covers, truck covers, tarps, agricultural bagging applications, and the like.

The addition of 0.45 wt % PEM improves the ball burst strength by about 17% as compared to the control as shown in Table 3. The addition of 0.15 wt % PEM improves the ball burst strength by 30% as compared to the control. The energy to burst increases by 52% and 56% respectively.

TABLE 3
Ball Burst

| | | | |
|---|---|---|---|
| Sample | Control | Inv. 1 | Inv. 2 |

Bursting Strength (N)

| | | | |
|---|---|---|---|
| 1 | 641 | 876 | 831 |
| 2 | 676 | 857 | 829 |
| 3 | 669 | 810 | 730 |
| 4 | 646 | 831 | 776 |
| 5 | 680 | 875 | 707 |
| 6 | 629 | 863 | 749 |
| Average | 656.8 | 852.0 | 770.3 |
| Std. Dev. | 21.0 | 26.3 | 51.5 |
| Max | 680 | 876 | 831 |
| Min | 629 | 810 | 707 |

Energy to Burst (J)

| | | | |
|---|---|---|---|
| 1 | 6.8 | 11.8 | 5.62 |
| 2 | 8 | 11.2 | 11.2 |
| 3 | 7.77 | 10.2 | 8.79 |
| 4 | 6.99 | 11.8 | 10.2 |
| 5 | 7.7 | 12 | 8.39 |
| 6 | 6.86 | 11.7 | 9.3 |
| Average | 7.4 | 11.5 | 8.9 |
| Std. Dev. | 0.5 | 0.7 | 1.9 |
| Max | 8 | 12 | 11.2 |
| Min | 6.8 | 10.2 | 5.62 |

Extension to Burst (mm)

| | | | |
|---|---|---|---|
| 1 | 29.9 | 33.5 | 26.3 |
| 2 | 32.4 | 33.3 | 33.8 |
| 3 | 31.6 | 32 | 32.3 |
| 4 | 30.2 | 35.2 | 35.1 |
| 5 | 31.3 | 34.7 | 32.3 |
| 6 | 29.2 | 34.4 | 33.7 |
| Average | 30.8 | 33.9 | 32.3 |
| Std. Dev. | 1.2 | 1.2 | 3.1 |
| Max | 32.4 | 35.2 | 35.1 |
| Min | 29.2 | 32 | 26.3 |

ASTM D2256 Standard Test Method was used to determine the tensile properties of yarns using the Single-Strand Method.

TABLE 4
Fiber Tensile Strength

| | Breaking Load | Elongation at |
|---|---|---|
| Sample | grams (lbs) | Break (%) |
| Control | 363 (0.8) | 19.7 |
| Inv. 1 | 544 (1.2) | 17.2 |
| Inv. 2 | 544 (1.2) | 16.2 |

The breaking load is improved relative to the control as shown in Table 4.

The invention has been described with reference to the preferred embodiments without limit thereto. Additional embodiments and improvements may be realized which are not specifically set forth herein but which are within the scope of the invention as more specifically set forth in the claims appended hereto.

Claimed is:

1. A fiber comprising:
90 wt % to 99.99 wt % thermoplastic resin; and
0.01 wt % to 10 wt % additive defined by Formula (I): 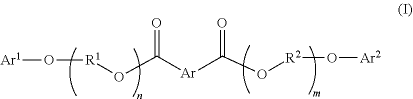
wherein:
Ar is selected from the group consisting of aryl, monosubstituted aryl and polysubstituted aryl, heteroaryl, monosubstituted heteroaryl and polysubstituted heteroaryl;
Ar¹ is selected from the group consisting of aryl, monosubstituted aryl and polysubstituted aryl, heteroaryl, monosubstituted heteroaryl and polysubstituted heteroaryl;
Ar² is selected from the group consisting of aryl, monosubstituted aryl and polysubstituted aryl, heteroaryl, monosubstituted heteroaryl and polysubstituted heteroaryl;
R¹ is an alkylene radical having 2-20 carbon atoms;
R² is an alkylene radical having 2-20 carbon atoms;
n=1-20; and
m=1-20.

2. The fiber of claim 1 wherein:
Ar is a 1,4-disubstituted phenyl group;
R¹ represents —CH₂CH₂—;
R² represents —CH₂CH₂—;
Ar¹ is phenyl;
Ar² is phenyl;
n=1; and
m=1.

3. The fiber of claim 1 wherein at least one of Ar¹ or Ar² is a naphthyl group.

4. The fiber of claim 1 wherein Ar is 1,2-substituted; 1,3-substituted or 1,4-substituted.

5. The fiber of claim 1 wherein said thermoplastic resin is selected from the group consisting of polyester, nylon, polypropylene and combinations thereof.

6. The fiber of claim 1 comprising at least 0.02 wt % of said additive.

7. The fiber of claim 1 comprising less than 5 wt % of said additive.

8. The fiber of claim 1 comprising at least 0.03 wt % to less than 3 wt % of said additive.

9. The fiber of claim 8 comprising at least 0.04 wt % to less than 1 wt % of said additive.

10. The fiber of claim 1 having an aspect ratio of at least 10:1.

11. The fiber of claim 10 wherein said aspect ratio is at least 100:1.

12. The fiber of claim 11 wherein said aspect ratio is at least 1,000:1.

13. The fiber of claim 12 wherein said aspect ratio is at least 1,000,000:1.

14. The fiber of claim 1 having an equivalent diameter of at least 1 micron to no more than 1 millimeter.

15. The fiber of claim 1 further comprising a modifier.

16. The fiber of claim 15 comprising up to 10 wt % of said modifier.

17. The fiber of claim 16 wherein said modifier is selected from the group consisting of tracers, delustrants, antistatic agents, flame retardants, colorants, pigments and cationic dying additives.

18. The fiber of claim 15 wherein said modifier is selected from the group consisting of metals, metal salts, TiO₂, Na-sulphoisophthalate, phosphinic acid compounds, and polyethylene glycol.

19. A carpet, garment, fabric, textile, tire cord, diaper fluff pulp or medical hygiene product comprising the fiber of claim 1.

20. A fiber matrix comprising:
a primary resin; and
a fibers wherein said fibers comprises:
90 wt % to 99.99 wt % thermoplastic resin; and
0.01 wt % to 10 wt % additive defined by Formula (I): 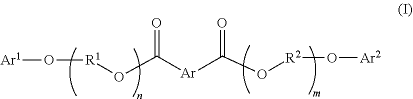
wherein:
Ar is selected from the group consisting of aryl, monosubstituted aryl and polysubstituted aryl, heteroaryl, monosubstituted heteroaryl and polysubstituted heteroaryl;
Ar¹ is selected from the group consisting of aryl, monosubstituted aryl and polysubstituted aryl, heteroaryl, monosubstituted heteroaryl and polysubstituted heteroaryl;
Ar² is selected from the group consisting of aryl, monosubstituted aryl and polysubstituted aryl, heteroaryl, monosubstituted heteroaryl and polysubstituted heteroaryl;
R¹ is an alkylene radical having 2-20 carbon atoms;
R² is an alkylene radical having 2-20 carbon atoms;
n=1-20; and
m=1-20.

21. The fiber matrix of claim 20 further comprising secondary fibers.

22. The fiber matrix of claim 21 wherein said secondary fibers are selected from the group consisting of natural fibers, man-made fibers, metallic fibers, carbon fibers, silicon fibers and polymer fibers.

23. The fiber matrix of claim 21 wherein said secondary fibers are selected from the group consisting of polyamides, polyesters, phenol-formaldehydes, polyvinyl chlorides, polyolefins, acrylic polyesters, aromatic polyamides, polyethylene, elastomers, polyurethanes and mixtures thereof.

24. The fiber matrix of claim 20 wherein a majority of said fibers are in a form selected from the group consisting of a woven matrix, an oriented matrix and a random matrix.

25. The fiber matrix of claim 20 wherein:
Ar is selected from the group consisting of a 1,4-disubstituted phenyl group a 1,3-disubstituted phenyl group and a 1,2-disubstituted phenyl group;
at least one of R¹ or R² represents —CH₂CH₂—;
at least one of Ar¹ or Ar² is phenyl;
n=1; and
m=1.

26. The fiber matrix of claim 20 wherein at least one of Ar¹ or Ar² is a naphthyl group.

27. The fiber matrix of claim 20 wherein Ar is 1,2-substituted; 1,3-substituted or 1,4-substituted.

28. The fiber matrix of claim 20 wherein said thermoplastic resin is selected from the group consisting of polyester, nylon, polypropylene and combinations thereof.

29. The fiber matrix of claim 20 comprising at least 0.02 wt % of said additive.

30. The fiber matrix of claim 20 comprising less than 5 wt % of said additive.

31. The fiber matrix of claim 20 comprising at least 0.03 wt % to less than 3 wt % of said additive.

32. The fiber matrix of claim 31 comprising at least 0.04 wt % to less than 1 wt % of said additive.

33. The fiber matrix of claim 20 wherein said fiber has an aspect ratio of at least 10:1.

34. The fiber matrix of claim 33 wherein said aspect ratio is at least 100:1.

35. The fiber matrix of claim 34 wherein said aspect ratio is at least 1,000:1.

36. The fiber matrix of claim 35 wherein said aspect ratio is at least 1,000,000:1.

37. The fiber matrix of claim 20 having an equivalent diameter of at least 1 micron to no more than 1 millimeter.

38. The fiber matrix of claim 20 comprising 5 to 85 wt % of said primary resin.

39. The fiber matrix of claim 20 wherein said primary resin comprises a material selected from the group consisting of polyester, nylon and polypropylene.

40. The fiber matrix of claim 20 further comprising a modifier.

41. The fiber matrix of claim 40 comprising up to 10 wt % of said modifier.

42. The fiber matrix of claim 40 wherein said modifier is selected from the group consisting of tracers, delustrants, antistatic agents, flame retardants, colorants, pigments and cationic dying additives.

43. The fiber matrix of claim 40 wherein said modifier is selected from the group consisting of metals, metal salts, TiO₂, Na-sulphoisophthalate, phosphinic acid compounds, and polyethylene glycol.

44. A carpet, garment, fabric, textile, tire cord, diaper fluff pulp or medical hygiene product comprising the fiber matrix of claim 20.

45. An article comprising fibers in a primary resin wherein said fibers comprise:
90 wt % to 99.99 wt % thermoplastic resin; and
0.01 wt % to 10 wt % additive defined by Formula (I): 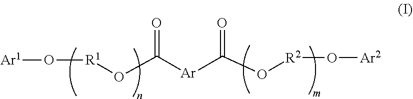
wherein:
Ar is selected from the group consisting of aryl, monosubstituted aryl and polysubstituted aryl, heteroaryl, monosubstituted heteroaryl and polysubstituted heteroaryl;
Ar¹ is selected from the group consisting of aryl, monosubstituted aryl and polysubstituted aryl, heteroaryl, monosubstituted heteroaryl and polysubstituted heteroaryl;
Ar² is selected from the group consisting of aryl, monosubstituted aryl and polysubstituted aryl, heteroaryl, monosubstituted heteroaryl and polysubstituted heteroaryl;
R¹ is an alkylene radical having 2-20 carbon atoms;
R² is an alkylene radical having 2-20 carbon atoms;
n=1-20; and
m=1-20.

46. The article of claim 45 comprising 5-85 wt % of said primary resin.

47. The article of claim 45 wherein said primary resin is selected from the group consisting of polyester, nylon, polypropylene and combinations thereof.

48. The article of claim 45 wherein said article is a reinforced article.

49. The article of claim 48 wherein said reinforced article further comprises secondary fibers.

50. The article of claim 49 wherein said secondary fibers are selected from the group consisting of natural fibers, man-made fibers, metallic fibers, carbon fibers, silicon fibers and polymer fibers.

51. The article of claim 45 wherein said secondary fibers are selected from the group consisting of polyamides, polyesters, phenol-formaldehydes, polyvinyl chlorides, polyolefins, acrylic polyesters, aromatic polyamides, polyethylene, elastomers, polyurethanes and mixtures thereof.

52. The article of claim 45 wherein a majority of said fibers form a matrix selected from the group consisting of a woven matrix, an oriented matrix and a random matrix.

53. The article of claim 45 wherein:
Ar is selected from the group consisting of a 1,4-disubstituted phenyl group a 1,3-disubstituted phenyl group and a 1,2-disubstituted phenyl group;
at least one of R¹ or R² represents —CH₂CH₂—;
at least one of Ar¹ or Ar² is phenyl;
n=1; and
m=1.

54. The article of claim 45 wherein at least one of Ar¹ or Ar² is a naphthyl group.

55. The article of claim 45 wherein Ar is 1,2-substituted; 1,3-substituted or 1,4-substituted.

56. The article of claim 45 wherein said thermoplastic resin is selected from the group consisting of polyester, nylon, polypropylene and combinations thereof.

57. The article of claim 45 comprising at least 0.02 wt % of said additive.

58. The article of claim 45 comprising less than 5 wt % of said additive.

59. The article of claim 45 comprising at least 0.03 wt % to less than 3 wt % of said additive.

60. The article of claim 59 comprising at least 0.04 wt % to less than 1 wt % of said additive.

61. The article of claim 45 wherein said fiber has an aspect ratio of at least 10:1.

62. The article of claim 61 wherein said aspect ratio is at least 100:1.

63. The article of claim 62 wherein said aspect ratio is at least 1,000:1.

64. The article of claim 63 wherein said aspect ratio is at least 1,000,000:1.

65. The article of claim 45 having an equivalent diameter of at least 1 micron to no more than 1 millimeter.

66. The article of claim 45 further comprising a modifier.

67. The article of claim 66 comprising up to 10 wt % of said modifier.

68. The article of claim 66 wherein said modifier is selected from the group consisting of tracers, delustrants, antistatic agents, flame retardants, colorants, pigments and cationic dying additives.

69. The article of claim 66 wherein said modifier is selected from the group consisting of metals, metal salts, TiO₂, Na-sulphoisophthalate, phosphinic acid compounds, and polyethylene glycol.

70. The article of claim 45 wherein said article is selected from the group consisting of carpets, garments, fabrics, textiles, tire cords, diaper fluff pulp or medical hygiene products.

71. A method for forming a material comprising:
mixing a thermoplastic resin and an additive to form a melt comprising 90 wt % to 99.99 wt % of said thermoplastic resin and 0.01 wt % to 10 wt % of said additive wherein said additive is defined by Formula (I): 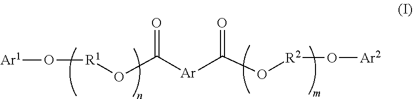
wherein:
Ar is selected from the group consisting of aryl, monosubstituted aryl and polysubstituted aryl, heteroaryl, monosubstituted heteroaryl and polysubstituted heteroaryl;
Ar¹ is selected from the group consisting of aryl, monosubstituted aryl and polysubstituted aryl, heteroaryl, monosubstituted heteroaryl and polysubstituted heteroaryl;
Ar² is selected from the group consisting of aryl, monosubstituted aryl and polysubstituted aryl, heteroaryl, monosubstituted heteroaryl and polysubstituted heteroaryl;
R¹ is an alkylene radical having 2-20 carbon atoms;
R² is an alkylene radical having 2-20 carbon atoms;
n=1-20;
m=1-20; and
extruding said melt to form fibers.

72. The method for forming a material of claim 71 further comprising mixing said fibers with secondary fibers to form a fiber matrix.

73. The method for forming a material of claim 72 wherein said secondary fibers are selected from the group consisting of natural fibers, man-made fibers, metallic fibers, carbon fibers, silicon fibers and polymer fibers.

74. The method for forming a material of claim 72 wherein said secondary fibers are selected from the group consisting of polyamides, polyesters, phenol-formaldehydes, polyvinyl chlorides, polyolefins, acrylic polyesters, aromatic polyamides, polyethylene, elastomers, polyurethanes and mixtures thereof.

75. The method for forming a material of claim 72 wherein a majority of said fibers form a matrix selected from the group consisting of a woven matrix, an oriented matrix and a random matrix.

76. The method for forming a material of claim 71 further comprising mixing said fibers with a primary resin to form a reinforced article.

77. The method for forming a material of claim 76 wherein said reinforced article comprises 5-85 wt % of said primary resin

78. The method for forming a material of claim 76 wherein said primary resin is selected from the group consisting of polyester, nylon, polypropylene and combinations thereof.

79. The method for forming a material of claim 71 wherein:
Ar is selected from the group consisting of a 1,4-disubstituted phenyl group a 1,3-disubstituted phenyl group and a 1,2-disubstituted phenyl group;
at least one of R¹ or R² represents —CH₂CH₂—;
at least one of Ar¹ or Ar² is phenyl;
n=1; and
m=1.

80. The method for forming a material of claim 71 wherein at least one of Ar¹ or Ar² is a naphthyl group.

81. The method for forming a material of claim 71 wherein Ar is 1,2-substituted; 1,3-substituted or 1,4-substituted.

82. The method for forming a material of claim 71 wherein said thermoplastic resin is selected from the group consisting of polyester, nylon, polypropylene and combinations thereof.

83. The method for forming a material of claim 71 comprising at least 0.02 wt % of said additive.

84. The method for forming a material of claim 71 comprising less than 5 wt % of said additive.

85. The method for forming a material of claim 17 comprising at least 0.03 wt % to less than 3 wt % of said additive.

86. The method for forming a material of claim 85 comprising at least 0.04 wt % to less than 1 wt % of said additive.

87. The method for forming a material of claim 71 having an aspect ratio of at least 10:1.

88. The method for forming a material of claim 87 wherein said aspect ratio is at least 100:1.

89. The method for forming a material of claim 88 wherein said aspect ratio is at least 1,000:1.

90. The method for forming a material of claim 89 wherein said aspect ratio is at least 1,000,000:1.

91. The method for forming a material of claim 71 having an equivalent diameter of at least 1 micron to no more than 1 millimeter.

92. The method for forming a material of claim 71 further comprising adding a modifier.

93. The method for forming a material of claim 92 comprising up to 10 wt % of said modifier.

94. The method for forming a material of claim 92 wherein said modifier is selected from the group consisting of tracers, delustrants, antistatic agents, flame retardants, colorants, pigments and cationic dying additives.

95. The method for forming a material of claim 92 wherein said modifier is selected from the group consisting of metals, metal salts, TiO₂, Na-sulphoisophthalate, phosphinic acid compounds, and polyethylene glycol.

96. The method for forming a material of claim 71 further comprising adding a first component and a second component to an extruder prior to said mixing wherein said first component comprises at least said thermoplastic resin and said second component comprises at least said additive.

97. The method for forming a material of claim 96 wherein said second component comprises up to 40 wt % of said additive.

98. The method for forming a material of claim 96 wherein one of said first said second component comprises 10-50 wt % of said additive and 50-90 wt % of said polymer.

99. The method for forming a material of claim 96 wherein said first component or said second component further comprises at least one modifier.

100. The method for forming a material of claim 96 wherein said first component or said second component comprises a carrier with at least one modifier in said carrier.

101. The method for forming a material of claim 71 further comprising adding a first component and a second component to an extruder prior to said mixing wherein said first component comprises at least said polymer selected from the group consisting of ethylene vinyl acetate, low density polyethylene, polyethylene terephthalate, polypropylene, oxidized polyethylene oxidized polypropylene, polystyrene, styrene acrylonitrile and polycarbonates and said second component comprises at least said additive.

102. The method for forming a material of claim 71 further comprising adding a first component to an extruder after said mixing wherein said first component comprises said thermoplastic resin and said additive.

103. The method for forming a material of claim 102 wherein said first component further comprises a modifier.

104. The method for forming a material of claim 71 wherein said extruding comprises extruding said thermoplastic resin and said additive to a spinneret to form extruded fibers.

105. The method for forming a material of claim 104 comprising allowing said extruded fibers to solidify to from said fibers.

106. The method for forming a material of claim 71 further comprising incorporating said fibers in an article selected from the group consisting of garments, fabrics, textiles, tire cords, diaper fluff pulp and medical hygiene products.
